(19) United States
(12) Patent Application Publication
(10) Pub. No.: US 2007/0110865 A1
(43) Pub. Date: May 17, 2007

(54) Method for producing pork bone extract

(76) Inventors: Akihito Fujimoto, Ibaraki (JP); Motokazu Nakayama, Tochigi (JP); Akira Higuchi, Ibaraki (JP); Takahisa Miyamoto, Fukuoka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/581,050

(22) PCT Filed: Nov. 26, 2004
(86) PCT No.: PCT/JP04/17975

§ 371 Date: May 30, 2006

(30) Foreign Application Priority Data
Nov. 28, 2003 (JP) 2003-398809

(51) Int. Cl. A23L 3/16

(52) U.S. Cl. 426/521

(57) ABSTRACT

The present invention relates to a method for producing a pork bone extract and a method for sterilizing a pork bone extract. Specifically, it relates to a method for producing a pork bone extract which comprises ultra high temperature (UHT) sterilization at a temperature of 130° C. or below, and a method for sterilizing a pork bone extract which comprises subjecting the pork bone extract to UHT sterilization at a temperature of 130° C. or below. According to the present invention, a pork bone extract with a little burnt odor which can be stored for a long period of time can be provided.

### TECHNICAL FIELD

The present invention relates to a method for producing a pork bone extract and a method for sterilizing a pork bone extract.

### BACKGROUND ART

Meat extracts are generally utilized as soup. As meat extracts are liable to deteriorate owing to contamination with bacteria, they require a sterilization treatment for long-term storage. As a method for sterilization treatment, heat sterilization is usually carried out because it is inexpensive and simple.

However, meat extracts are likely to be contaminated with highly thermoduric microorganisms generally called spore-forming bacteria, for example, those belonging to the genera Bacillus, Clostridium, etc. To prevent the contamination, it is necessary to carry out a prolonged sterilization treatment such as retort sterilization.

Although retort sterilization permits long-term storage, it involves the problem that cooked odor is generated owing to heating for a long time.

In heat sterilization, if heating time is shortened to avoid generation of cooked odor, sterilization may be insufficient, making it highly possible for meat extracts to be contaminated with spore-forming bacteria. Particularly, among spore-forming bacteria, Bacillus stearothermophilus is highly thermoduric, and if heat treatment is insufficient, its spores are very likely to remain.

For the purpose of efficient sterilization of liquid food and drink, there have been proposed methods in which heating is carried out after adding an additive and methods comprising pressurizing, in addition to the methods comprising simply heating food and drink. Examples of known additives include lysozyme and sucrose fatty acid ester (Japanese Published Unexamined Patent Application No. 234808/02), sucrose fatty acid ester (Japanese Published Unexamined Patent Application No. 18578/81), lauric acid monoglyceride (Japanese Published Unexamined Patent Application No. 61630/76), diglycerin fatty acid ester (Japanese Published Unexamined Patent Application No. 39354/95) and polyglycerin fatty acid ester (Japanese Published Unexamined Patent Application No. 163678/87). Even in the case of adding an additive, however, treatment at 121° C. for 30 minutes or thereabout is considered to be necessary, and influence of heating may be caused. These methods also involve the problem that flavor may be deteriorated by the additives. In addition, there is known a method in which sucrose fatty acid ester is added and heating and pressurization are further carried out (Japanese Published Unexamined Patent Application No. 284949/93). However, when this method is applied to a meat extract, gelatin, which is a main component of meat extract, may be decomposed to deteriorate the quality of the meat extract.

High temperature short time sterilization methods such as ultra high temperature sterilization (hereinafter referred to as UHT sterilization) method are known as methods for sterilization treatment of liquid food with less influence of heating on flavor.

Although a meat extract as a liquid food and drink can be treated by UHT sterilization, the problem is that spore-forming bacteria are liable to remain because the heating time is short in UHT sterilization.

Pork bone extract is a kind of meat extract obtained by extracting pork bone with an aqueous medium and is widely used for “Tonkotsu Ramen” or Chinese noodle in pork bone soup, etc.

As in the case of other meat extracts, methods that enable efficient sterilization without deteriorating the quality are desired for pork bone extract.

### DISCLOSURE OF THE INVENTION

An object of the present invention is to provide a method for sterilizing a pork bone extract and a method for producing a pork bone extract using the sterilization method.

The present invention relates to the following (1) to (6).

(1) A method for producing a pork bone extract, which comprises UHT sterilization at a temperature of 130° C. or below.

(2) The method according to the above (1), wherein the UHT sterilization is carried out at 120 to 130° C.

(3) The method according to the above (1) or (2), wherein the UHT sterilization is carried out for 10 to 20 seconds.

(4) A method for sterilizing a pork bone extract, which comprises subjecting the pork bone extract to UHT sterilization at a temperature of 130° C. or below.

(5) The method according to the above (4), wherein the UHT sterilization is carried out at 120 to 130° C.

(6) The method according to the above (4) or (5), wherein the UHT sterilization is carried out for 10 to 20 seconds.

### BEST MODES FOR CARRYING OUT THE INVENTION

In the present invention, “pork bone extract” refers to a liquid extract obtained by extracting pork bone or pig's feet with an aqueous medium or the like.

The parts used as a raw material for the extraction include pork bone and pig's feet, which may be used alone or as a mixture.

Extraction from the raw material is carried out using an extraction medium such as an aqueous medium or an organic solvent, and an aqueous medium is preferably used.

Examples of the aqueous media include water and aqueous solutions of inorganic salts. Examples of the inorganic salts include sodium chloride, potassium chloride and calcium chloride.

As the organic solvent, ethanol is preferably used in view of the use for food and drink. Ethanol may be water-containing ethanol, and one with a moisture content of 10% (v/v) to 90% (v/v) is preferably used.

The extraction medium may have any pH. Preferred is pH 6 to 10 and more preferred is pH 7 to 9.

Extraction is carried out by adding the extraction medium to the above-mentioned raw material and heating the mixture at 60 to 150° C. for 30 minutes to one week, preferably for 30 minutes to 24 hours.

For the extraction, any apparatus may be used so long as proteins, peptides and other taste elements can be extracted from the raw material under heating conditions, preferably under heating and pressurizing conditions. Examples of the apparatus include heating apparatus such as an atmospheric cooker and a pressure cooker, and a pressure cooker is preferably used.

After the extraction operation, a liquid extract is obtained according to a solid-liquid separation method such as cake filtration, clarifying filtration, centrifugal filtration, a method using a filter press, sedimentation separation, centrifugal sedimentation or pressing separation, and the obtained liquid extract can be used as the pork bone extract.

When the solid-liquid separation is carried out, oil and fat generated during the extraction operation may be separated using an apparatus that can separate oil and fat such as a three-layer separator. The liquid extract obtained by separating oil and fat is clear and can be used as a clear pork bone extract.

The liquid extract obtained by the solid-liquid separation may be concentrated by various means such as heat concentration, freeze concentration, reverse osmosis concentration and vacuum concentration, and the thus obtained concentrate may be used as the pork bone extract.

The liquid extract from which oil and fat has not been separated or its concentrate may be directly subjected to emulsification using TK homomixer, colloid mill, high pressure homogenizer, votator, ultrasonic generator, etc. In the case of the liquid extract from which oil and fat has been separated or its concentrate, emulsification is carried out after addition of an appropriate amount of the separated oil and fat, or an animal oil and fat such as bone oil, lard, chicken oil, beef tallow or milk fat, or a vegetable oil and fat such as rapeseed oil, soybean oil, palm oil, corn oil, rice bran oil, palm kernel oil, safflower oil, sesame oil or cotton seed oil. In either case, the resulting emulsion can also be used as the pork bone extract.

Although the amount of the oil and fat to be added is not particularly limited, it is preferred to add the oil and fat so that its concentration in the pork bone extract is 0.5 to 60% (v/v), preferably 10 to 40% (v/v).

The pork bone extract thus obtained by emulsification is suitably used as baitang soup.

The pork bone extract obtained above may contain various additives that can be used for food and drink, such as inorganic salts, acids, sugars, seasonings and spices, according to need.

Examples of the inorganic salts include sodium chloride, potassium chloride and ammonium chloride. Examples of the acids include ascorbic acid, fumaric acid, malic acid, tartaric acid, citric acid and carboxylic acids such as fatty acid, and salts thereof. Examples of the salts include sodium salt and potassium salt. Examples of the sugars include sucrose, glucose and lactose. Examples of the seasonings include soy sauce and miso (fermented soybean paste), and the spices include various spices. The amount of these additives used may be properly determined according to the purpose of use. For example, they can be used in an amount of 0.1 to 500 parts by weight per 100 parts by weight of the pork bone extract.

The pork bone extract used in the present invention may be any of the above-mentioned pork bone extracts. It may also be commercially available pork bone extract. The soluble solid content (Brix) of the pork bone extract may be any value and is preferably 50 or less.

UHT sterilization of the pork bone extract is preferably carried out after the preparation of the above pork bone extract.

The UHT sterilization according to the present invention may be carried out either by direct heating methods or by indirect heating methods. Examples of the direct heating methods include the steam injection method in which high pressure steam is directly injected into the pork bone extract, the steam infusion method in which the pork bone extract is injected into high pressure steam and the Joule heating method which comprises passing an electric current through the pork bone extract, and those of the indirect heating methods include methods using a plate-type heat exchanger, a tube-type heat exchanger, a scraped-surface heat exchanger, etc.

To carry out the UHT sterilization, any apparatus may be used so long as it enables the above UHT sterilization. Examples of the apparatus include Aseprizer SDI (for sterilization by direct steam heating, Izumi Food Machinery Co., Ltd.), Joule Heating Sterilization System FJL Series (for Joule heating method, Frontier Engineering Co., Ltd.), Aseprizer PHX (for sterilization by plate-type indirect heating, Izumi Food Machinery Co., Ltd.), Aseprizer SHE (for sterilization by scraped-surface indirect heating, Izumi Food Machinery Co., Ltd.), Aseprizer THX (for sterilization by tube-type indirect heating, Izumi Food Machinery Co., Ltd.) and Small Volume Liquid Continuous Sterilization Testing Machine RMS (Hisaka Works Co., Ltd.).

In the present invention, the conditions for the UHT sterilization can be appropriately set according to the components of the pork bone extract, the kind and number of microorganisms in the pork bone extract, etc. so far as the treatment temperature is 130° C. or below. The treatment temperature is 120 to 130° C., preferably 120 to 125° C. At the treatment temperature of 120 to 125° C., the treatment time is preferably 5 to 60 seconds, more preferably 10 to 30 seconds, further preferably 10 to 20 seconds. At 125 to 130° C., the treatment time is preferably 5 to 30 seconds, more preferably 10 to 20 seconds.

It is preferred that the UHT sterilization of the present invention is carried out under such conditions that can produce a sterilization effect equal to or better than that obtained, when the pH of the pork bone extract is less than 4.0, by heat sterilization at 65° C. for 10 minutes, and when the pH of the pork bone extract is 4.0 or more, by heat sterilization at 85° C. for 30 minutes, respectively.

It is preferred that after the completion of UHT sterilization, the resulting pork bone extract is aseptically packed in a sterile container.

By subjecting the pork bone extract to the UHT sterilization under the above-mentioned conditions, a pork bone extract with a little burnt odor which can be stored for a long period of time can be obtained.

Examples of the present invention are shown below.

### EXAMPLE 1

Pork bone (40 kg) and 80 kg of tap water were placed in a pressure extractor (Komatsugawa Chemical Engineering Co., Ltd.) and heated at 120° C. for 120 minutes. The resulting mixture was allowed to stand overnight for natural cooling, and the liquid portion was obtained from the outlet provided at the lower part of the extractor so that the floating oil and fat was not contained therein. The obtained liquid was concentrated using Evapor CEP1 (Okawara Mfg. Co., Ltd.) to obtain about 48 kg of a liquid having a Brix value of 10. The concentrated liquid was used as the pork bone extract for the following experiment.

On the other hand, 150 kg of a mixture of chicken meat and chicken bone and 350 kg of water were placed in a pressure extractor (Komatsugawa Chemical Engineering Co., Ltd.) and heated at 115° C. for 60 minutes. The resulting mixture was allowed to stand for natural cooling, and the liquid portion was obtained from the outlet provided at the lower part of the extractor so that the floating oil and fat was not contained therein. The obtained liquid was concentrated using Evapor CEP1 (Okawara Mfg. Co., Ltd.) to obtain about 140 kg of a liquid having a Brix value of 10. The concentrated liquid was used as the chicken extract for the following experiment.

The pork bone extract and the chicken extract prepared above were subjected to UHT sterilization using Small Volume Liquid Continuous Sterilization Testing Machine RMS (Hisaka Works Co., Ltd.) under the conditions of temperature and time shown in Table 1. The sterilized extracts were incubated at 37° C. and 50° C. for one week. After the incubation, a one ml sample was aseptically taken from each of the extracts and poured onto an aseptic plate, and 20 to 30 ml of a nutrient agar medium (Nissui Pharmaceutical Co., Ltd., containing 35 g of meat extract, 10 g of peptone, 15 g of sodium chloride and 15 g of agar in one 1 of water) was further poured thereto.

The agar media containing the extracts incubated at 37° C. were incubated at 37° C. for 24 hours. Likewise, the agar media containing the extracts incubated at 50° C. were incubated at 50° C. for 24 hours. After the incubation, the presence or absence of colony appearance was examined on each agar medium. If a colony, even only one, is confirmed, the presence of colony appearance was acknowledged.

As a result, no growth of microorganisms was observed on the agar media incubated at 37° C. containing the pork bone extract and the chicken extract which were subjected to the UHT sterilization under the conditions shown in Table 1, irrespective of the UHT sterilization conditions. That is, as to the pork bone extract and the chicken extract, it was confirmed that at least microorganisms other than spore-forming bacteria were killed when the UHT sterilization was carried out under any of the conditions shown in Table 1.

However, among microorganisms that are classed as spore-forming bacteria, those which do not grow at 37° C. but grow at 50° C. are known to exist.

The presence or absence of colony formation on the agar media containing the extracts incubated at 50° C. is shown in Table 1.

In the table, “+” indicates that colony formation was observed, and “−” indicates that no colony formation was observed.

On the other hand, a sensory test was conducted by 16 panelists with respect to the burnt odor of the pork bone extract after the above-described UHT sterilization.

Evaluation was carried out according to a seven-scale rating system wherein no burnt odor at all was designated as one point and appreciable burnt odor as 7 points.

The mean value of the scores of 16 panelists was calculated and the burnt odor was designated as “not perceived” where the mean value was 1 or more and less than 2; as “slightly perceived” where the mean value was 2 or more and less than 3; as “somewhat perceived” where the mean value was 3 or more and less than 4; as “perceived” where the mean value was 4 or more and less than 6; and as “appreciably perceived” where the mean value was 6 or more and less than 7.

The results are shown in Table 1.

TABLE 1

| | | Presence or | | |
|---|---|---|---|---|
| | | absence of colonies | | |
| Treatment | Treatment | Pork | | |
| temp. | time | bone | Chicken | Burnt odor (pork |
| (° C.) | (sec.) | extract | extract | bone extract) |
| 110 | 10 | + | + | Slightly perceived |
| | 20 | + | + | Slightly perceived |
| | 30 | + | + | Slightly perceived |
| | 50 | + | + | Somewhat perceived |
| 115 | 10 | + | + | Not perceived |
| | 20 | + | + | Slightly perceived |
| | 30 | + | + | Slightly perceived |
| | 50 | + | + | Somewhat perceived |
| 120 | 10 | − | + | Not perceived |
| | 20 | − | + | Slightly perceived |
| | 30 | − | + | Slightly perceived |
| | 50 | − | + | Somewhat perceived |
| 125 | 10 | − | + | Not perceived |
| | 20 | − | + | Somewhat perceived |
| | 30 | − | + | Somewhat perceived |
| | 50 | − | + | Somewhat perceived |
| 130 | 10 | − | + | Not perceived |
| | 20 | − | + | Perceived |
| | 30 | − | + | Perceived |
| | 50 | − | + | Perceived |
| 135 | 10 | − | − | Perceived |
| | 20 | − | − | Appreciably perceived |
| | 30 | − | − | Appreciably perceived |
| | 50 | − | − | Appreciably perceived |

As shown in Table 1, colony formation was confirmed on the agar media containing the chicken extract which was subjected to the UHT sterilization at a temperature of 130° C. or below, but no colony formation was observed on the agar media containing the pork bone extract which was subjected to the UHT sterilization at 120 to 130° C.

Further, no burnt odor was perceived with respect to the pork bone extract that was subjected to the UHT sterilization at 120 to 130° C. for 10 seconds.

### EXAMPLE 2

Three strains of Bacillus stearothermophilus isolated from unsterilized meat extract were respectively spread onto a nutrient agar medium (Nissui Pharmaceutical Co., Ltd., containing 35 g of meat extract, 10 g of peptone, 15 g of sodium chloride and 15 g of agar in one 1 of water; the same applies hereunder) and cultured at 50° C. for 48 hours.

Part of the cells grown on the agar medium were collected and microscopically examined to confirm that the spores were formed.

After the spore formation was confirmed, the cells on the agar medium were collected by scraping and suspended in sterile water, and the suspension was heated in boiling water for 10 minutes, followed by centrifugation for 10 minutes. The obtained precipitate was suspended in sterile water again, and the suspension was heated in boiling water for 10 minutes, followed by centrifugation for 10 minutes. The obtained precipitate was suspended in sterile water to make the spore concentration of 3×10⁴ to 3×10⁵ spores/ml, and the suspension was used in the following tests as the spore suspension of each of the Bacillus stearothermophilus strains.

The pork bone extract obtained in Example 1 was designated as pork bone extract 1 and was concentrated using Evapor CEP1 (Okawara Mfg. Co., Ltd.) to prepare pork bone extract 2 having a Brix value of 35.

To 17 kg of pork bone extract 2 was added 7.3 kg of pork bone oil (Zenmi Shokuhin Co., Ltd.), and the mixture was pre-emulsified using TK Homogenizer (Tokushu Kika Kogyo Co., Ltd.) at 10,000 r.p.m. for 10 minutes and successively emulsified using a high pressure homogenizer (SMT) at a processing pressure of 300 kg/kg. The pork bone extract obtained by the emulsification was designated as pork bone extract 3. The Brix value of pork bone extract 3 was 43.

To 3000 ml of each of pork bone extracts 1 to 3 and the chicken extract prepared in Example 1 was added 30 ml of each of the spore suspensions of the three strains of Bacillus stearothermophilus prepared above.

Each of the extracts to which the spore suspensions were added was subjected to UHT sterilization at 125° C. for 10 seconds using Small Volume Liquid Continuous Sterilization Testing Machine RMS (Hisaka Works Co., Ltd.).

Each of the extracts sterilized was aseptically divided into two equal portions. One was incubated at 37° C. for one week and the other was incubated at 50° C. for one week.

After the incubation, a one ml sample was aseptically taken from each of the extracts and spread onto the nutrient agar medium. The agar media each containing the pork bone extract or the chicken extract incubated at 37° C. were incubated at 37° C. for 24 hours and those each containing the pork bone extract or the chicken extract incubated at 50° C. were incubated at 50° C. for 24 hours to examine the presence or absence of colony formation.

As a result, no colony formation was observed on the agar media incubated at 37° C. with respect to any of the extracts.

Table 2 shows the results obtained by carrying out the incubation at 50° C. Since the same results were obtained for the three strains of Bacillus stearothermophilus, the results are shown in one table.

TABLE 2

| | Brix | Colony formation |
|---|---|---|
| Chicken extract | 10 | Formed |
| Pork bone extract 1 | 10 | Not formed |
| Pork bone extract 2 | 35 | Not formed |
| Pork bone extract 3 | 43 | Not formed |

As shown in Table 2, as regards the pork bone extracts, when the spores of Bacillus stearothermophilus, a kind of spore-forming bacteria that are considered to be liable to remain when meat extract is subjected to UHT sterilization, were added, no colony formation was observed by carrying out the UHT sterilization, whereas colony formation was observed with the chicken extract although the UHT sterilization was carried out.

Further, as a result of a sensory test carried out in a manner similar to that in Example 1 with respect to the burnt odor of the pork bone extracts and the chicken extract, no burnt odor was perceived for any of the extracts.

### INDUSTRIAL APPLICABILITY

According to the present invention, a pork bone extract with a little burnt odor which can be stored for a long period of time can be provided.

1. A method for producing a pork bone extract, which comprises ultra high temperature sterilization at a temperature of 130° C. or below.

2. The method according to claim 1, wherein the ultra high temperature sterilization is carried out at 120 to 130° C.

3. The method according to claim 1, wherein the ultra high temperature sterilization is carried out for 10 to 20 seconds.

4. A method for sterilizing a pork bone extract, which comprises subjecting the pork bone extract to ultra high temperature sterilization at a temperature of 130° C. or below.

5. The method according to claim 4, wherein the ultra high temperature sterilization is carried out at 120 to 130° C.

6. The method according to claim 4, wherein the ultra high temperature sterilization is carried out for 10 to 20 seconds.

7. The method according to claim 2, wherein the ultra high temperature sterilization is carried out for 10 to 20 seconds.

8. The method according to claim 5, wherein the ultra high temperature sterilization is carried out for 10 to 20 seconds.
